(19) United States
(12) Patent Application Publication
(10) Pub. No.: US 2025/0255343 A1
(43) Pub. Date: Aug. 14, 2025

(54) Ceramic Wick

(71) Applicant: JT International SA, Geneva (CH)

(72) Inventor: Jaakko McEvoy, Vienna (AT)

(73) Assignee: JT International SA, Geneva (CH)

(21) Appl. No.: 18/833,461

(22) PCT Filed: Jan. 26, 2023
(86) PCT No.: PCT/EP2023/051896

§ 371 Date: Jul. 26, 2024

(30) Foreign Application Priority Data
Jan. 26, 2022 (EP) 22153410.0

(51) Int. Cl. A24F 40/44; A24F 40/10; A24F 40/465; A24F 40/48; H05B 6/10

(52) U.S. Cl. CPC A24F 40/44; A24F 40/10; A24F 40/465; A24F 40/48; H05B 6/108

(57) ABSTRACT

A cylindrical ceramic wick for an aerosol generating device includes a hollow core and a base, wherein the base includes at least one indentation arranged such that, when, in use, the indentation engages with a cylindrical cup, an airflow path for allowing air to flow from the exterior of the wick into the hollow core is defined.

### TECHNICAL FIELD

The present invention relates to a cylindrical ceramic wick for an aerosol generating device. More specifically, it relates to an aerosol generating device such as an e-cigarette, heat-not-burn devices and the like which are capable of producing an aerosol. The wick has structured ends for allowing air to flow from an exterior of the wick into the interior of the wick.

### BACKGROUND

Inhalers or aerosol generating devices such as e-cigarettes or vaping devices are becoming increasingly popular. They generally heat or warm an aerosolisable substance to generate an aerosol for inhalation, as opposed to burning tobacco as in conventional tobacco products.

Some aerosol generating devices include a wicking element or wick for transporting a liquid aerosolisable substance from a liquid reservoir to a heater to be vaporised, mixed with air, and subsequently inhaled.

Commonly used wicking materials include cotton and porous or permeable ceramic. However, current wicking elements often leak unvaporised fluid, resulting in the substance being wasted, and negatively affecting the user experience. Moreover, existing wicks do not form part of the airflow path of a device, which results in the aerosol vapor mixing with air in an unpredictable and inconsistent way. By this we mean that the quantity or temperature of the vaporised liquid inhaled in each puff taken by the user may vary between puffs. This results in an unsatisfactory user experience.

Therefore a need exists to provide a wick that can address these issues.

### SUMMARY

An aspect of the present invention provides a cylindrical ceramic wick for an aerosol generating device. The wick comprises a hollow core and a base, wherein the base comprises at least one indentation arranged such that, when, in use, the indentation engages with a cylindrical cup, an airflow path for allowing air to flow from the exterior of the wick into the hollow core is defined.

Advantageously, the ceramic wick allows for air to flow from the exterior to the interior of the wick when the wick engages a cup in use. That is, the wick forms part of the airflow path. If any liquid moving through the wick is not vaporised, and leaks from the wick, then in use, this can be collected in the cup and re-absorbed by the indentations engaging the cup. In this way, liquid is not wasted, and the user user's experience is improved.

Further, since the wick forms part of the airflow path, in use, vaporised liquid is consistently combined with air. This ensures that the quality and other characteristics, such as temperature and density, of the inhaled aerosol does not vary between puffs, which improves the user experience.

The indentation may be formed by sintering, or by machining the base. Forming the indentation in either of these ways is reliable and efficient.

In some examples the wick comprises a cylindrical susceptor arranged on an outer surface of the wick, wherein the susceptor comprises a magnetic material. By arranging a susceptor on the outer surface of the wick, the fluid being transported through the wick can be efficiently heated, for example by an inductor, into a vapor for inhalation. The susceptor may have a plurality of perforations in its surface, which allows vaporised fluid to be emitted into the airflow path.

Advantageously the wick may be housed by a cylindrical cup. In this way, air is directed around the wick and/or susceptor, assisting in dispersing vaporised fluid into the airflow path. Further, any fluid that is not vaporised, or that is returned against the airflow channel is collected in the cup and reabsorbed by the indentations that engage the cup.

Preferably the cylindrical cup may comprise at least one annular induction coil. A current may be passed through the induction coil to induce eddy currents in the susceptor. This causes the susceptor to heat up rapidly, thereby vaporising liquid in the wick. The combination of an induction coil and a susceptor is an especially efficient method of heating the wick.

In some advantageous examples a gap between the wick and the cup defines the airflow path. This encourages air to flow over an exterior surface of the wick and susceptor, which in turn ensures that vapor released from the wick is efficiently transported via the airflow path, to the user.

Preferably, the base preferably comprises between 2 and 20 indentations. Even more preferably, the base more preferably comprises between 8 and 12 indentations.

In some examples, the at least one indentation is defined by a height, the height being between 0.1 mm and 5 mm. More preferably the height of each indentation is between 0.5 mm and 2 mm.

In some examples, the at least one indentation may be defined by a width, the width being between 0.5 mm and 10 mm. Preferably the width of each indentation may be between 1 mm and 3 mm. The width of each indentation may vary across a length of the indentation.

By varying the number of indentations, or the height or the width of the indentation, the flow rate supported by the airflow path can be adjusted to match a preferred flow rate. For example, if a high flow rate through the airflow channel is sought, then a relatively high number of indentations may be used. Alternatively or additionally, the height and width of each indentation may be tuned as required.

It is to be understood that the ranges specified above are merely examples, and the skilled person would be well aware of another number of indentations that could be provided, or another value for the height or width or each indentation than those specified above.

In some examples, each indentation may extend in a radial direction of the wick. This allows for air to flow efficiently along the air flow path.

Alternatively, each indentation may extend at an angle not aligned with a radial direction of the wick. This is particularly advantageous, and causes air to flow in a swirling pattern in the airflow path. This is beneficial for ensuring that the vaporised substance is properly dispersed and mixed into the air intake.

Additionally, the cup may be formed of a heat resistant material, thereby preventing the cup from being burned by the susceptor.

Advantageously, the heat resistant material may be polyetheretherketone, PEEK, polyimide or ceramic. This allows the cup to withstand especially high temperatures, which is desirable when the user wishes to engage in high temperature vaping.

In some preferable examples, the cup may comprise a wall with a thickness between 0.2 mm and 4 mm. Even more preferably, the thickness may be between 0.5 mm and 2 mm. Altering the wall thickness affects the extent to which the induction coil induces heat in the susceptor. Therefore the temperature to which the susceptor is heated may be adjusted.

Advantageously, the cup may comprise an interior base with a raised tapered central section. By raising the central section along a taper any fluid collected in the cup naturally flows to the lower section of the cup, where the indentations engage with the cup. The taper encourages fluid to flow into the indentations which assists in absorption of fluid.

In some examples, the cup may comprise a first end which forms at least one indentation defined by a width and a height. This allows the cup to sit securely against a surface while allowing air to flow through it.

A second aspect of the invention provides an aerosol generating device comprising the wick of the first aspect.

### BRIEF DESCRIPTION OF THE DRAWINGS

An exemplary ceramic wick will now be described by way of example with reference to the accompanying drawings, in which:

FIG. 1 shows an example ceramic wick, including indentations;

FIG. 2 shows another view of the ceramic wick illustrated in FIG. 1;

FIG. 3 shows a schematic of the example ceramic wick in use, where the wick is housed in a cup, and the indentations engage the cup;

FIG. 4 shows a cross-sectional view of the example ceramic wick housed in a cup;

FIGS. 5A and 5B show an example of the ceramic wick housed in a cup, the cup having a raised tapered central section; and

FIG. 6 shows another example of the ceramic wick housed in a cup, the cup also having structured ends.

### DETAILED DESCRIPTION

Next, various aspects of the invention will be described. Note that the same or similar portions are denoted with the same or similar reference signs in the descriptions of the drawings below. Note that the drawings are schematic, and a ratio of each size in the drawings may be different from a real one. Therefore, specific sizes and dimensions should be judged in consideration of the following description.

Examples of the present disclosure relate to a ceramic wick having structured ends, or indentations, which engage with a cup or other surface in use. The wick is cylindrical, and typically made of porous ceramic. The wick therefore provides wicking action for an aerosolisable substance, such as a vaping liquid, also known as an e-liquid. In addition, because, in use, the indentations engage a cup, an airflow path is defined from the exterior of the wick to the interior. When the wick engages a cup, the indentation forms part of an airflow path that facilitates airflow from the exterior of the wick into the hollow core.

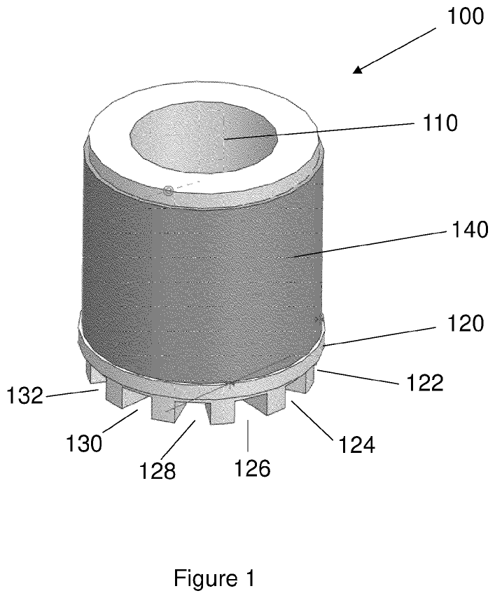

Referring to FIG. 1, an example of a cylindrical ceramic wick 100 is shown. The wick 100 includes a hollow core 110 and base 120. Also shown is susceptor 140, which covers the outer surface of the cylindrical wick 100. Note that in this example the susceptor 140 is a separate component to the wick 100, and can be removed and replaced if needed. The base 120 further comprises one or more indentations, such as indentations 122, 124, 126, 128, 130 and 132. At least one indentation is arranged on the base 120, but preferably, between 2 and 20 indentations are arranged around the base 120, and even more preferably between 8 and 12 indentations are arranged on the base 120.

Each indentation has a height. The height may be between 0.1 millimeters (mm) to 5 mm, or more preferably between 0.5 mm and 2 mm. Similarly, each indentation has a width. The width may be between 0.5 mm and 10 mm, or more preferably between 1 mm and 3 mm. The height and the width can be adjusted independently of each other. The above ranges are merely examples, and the skilled reader would readily understand that other heights and widths may also be used. The number of indentations is also variable. The wick 100 will function with only one indentation, but a plurality of indentations are preferred as discussed above.

As shown, the indentations 122, 124 typically extend in a radial direction away from the center of the cylindrical structure. In another example, they extend away from the center of the wick 100 at an angle not aligned with a radial direction. For example, an indentation may be offset by 20, 30 or 40 degrees from the radial direction. Other levels offset are of course possible. In some examples, the width of the indentation varies along the length of the indentation. By this we mean that at the exterior of the wick 100, the indentation 124, 126 has a first width, and in the interior of the wick 100, the indentation has a second width different to the first width. Accordingly, the second width may be larger or smaller than the first width.

Varying the dimensions and the number of indentations improves the airflow capacity of the wick 100, as well as the extent to which inhaled air may be mixed with vapor in the airflow path. This is advantageous depending on the specific intended application of the wick. For example, if the user wishes to generate a large quantity of vapor, the number and size of the indentions may be adjusted to accommodate this. Similarly, if a highly uniform vapor is desired in terms of temperature and dispersion of the vapor in the inhaled air, this may also be achieved by adjusting the number and dimension of indentations.

Another advantage of the wick 100 is that it forms part of the airflow path 150. Due to the arrangement of the indentations 122, 124, air may flow unimpeded through the wick 100 while also mixing with vaporised e-liquid. This can assist in reducing the cross-sectional profile of an aerosol generating device.

As discussed, the wick 100 can be formed of a porous ceramic. The wick 100 may be formed in a number of ways. For example, the wick 100 and the indentation 122, 124 may be formed as one piece by sintering. Alternatively, the wick 100 may first be formed as a cylindrical structure, and then the indentations may be formed by removing excess material from the cylindrical structure. The material may be removed by machining, milling, cutting, or any other method known for manipulating ceramic or other materials. It is to be understood that by forming the ceramic with indentations 122, 124, or by removing ceramic material to create indentations, a corresponding castellation, or tooth, is formed in the ceramic wick. Each indentation that is formed may result in the formation of a corresponding castellation.

Referring to the Figures, each castellation is shown as having a rectangular cross-section. This is especially effective for providing good contact between the castellation and the surface engaging the castellation. However, in other examples, each castellation may have a different cross-section, such as triangular, or semi-circular.

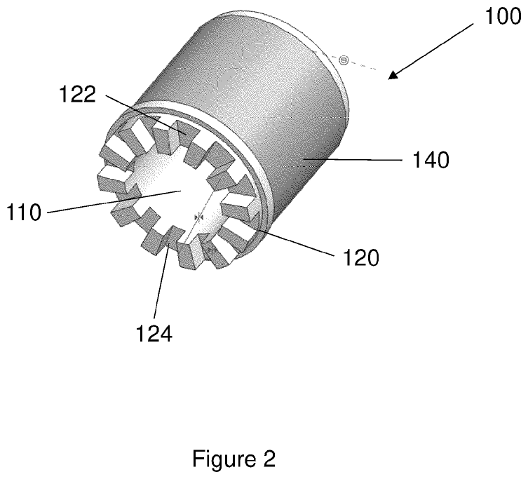

As can be seen from FIG. 2, when a plurality of indentations, such as indentations 122 and 124, are present, these may be spaced around the base 120 at even intervals. Alternatively, the indentations 122, 124 may be arranged in one or more groups. The placement and distribution of the indentations 122, 124 can alter the resulting air intake properties of the wick 100 when it is used dependent upon the desired end result.

The ceramic is able to withstand the high temperatures encountered in such devices. The ceramic may be a porous ceramic, meaning that the ceramic has a porous internal structure. A porous structure allows the wick 100 to draw e-liquid from a reservoir into the wick 100 via capillary action. The porosity of the ceramic may be chosen to give the ceramic wick a certain wicking rate, depending on the intended use of the wick 100. For example, a more porous ceramic wick may be preferred for producing large volumes of aerosol.

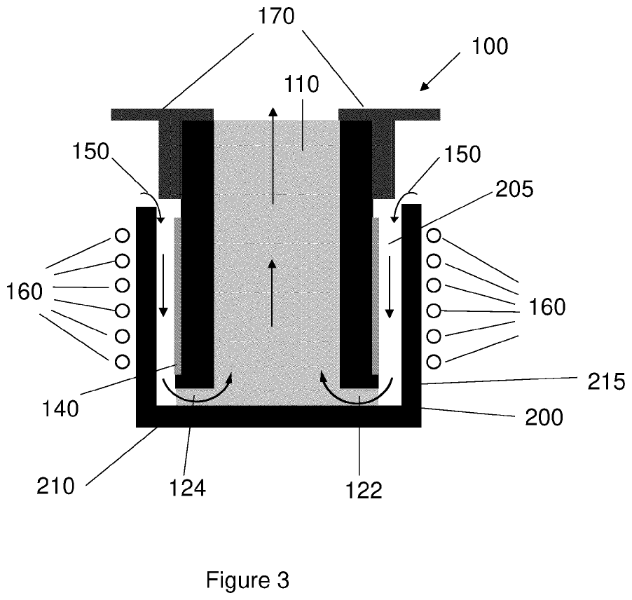

Referring now to FIG. 3, which schematically shows an example of the wick 100 housed in a cup 200, it can be seen that in use, the indentations 122, 124 engage with the cup 200. In practice, this is achieved when the castellation rests on the inner surface of the cup base 210. The cup 200 is typically cylindrical, though other shapes are possible. Importantly, the cup 200 must be large enough to house the wick 100 within the cup 200.

The cup 200 may comprise a side wall 210. In an example where the cup 200 is cylindrical, this corresponds to the circumferential surface of the cup 200. The thickness of the wall 215 may be variable. In some examples, a thickness of between 0.2 mm and 4 mm is preferred, while in other examples, the thickness may be between 0.5 mm and 2 mm.

In this example, an airflow path 150 is defined by the gap 205 between the cup 200 and the exterior of the wick 100. This allows air to flow from outside of the cup 200, through the gap 205, then the indentations 122 and 124, into the hollow core 110 of the wick 100. In another example, when the wick 100 is arranged in an aerosol generating device, the airflow path 150 may facilitate air to flow through the wick 100 in response to the user inhaling air through the wick 100.

Also shown in FIG. 3, are components 170, induction coils 160 and susceptor 140. In an example, when the wick 100 and cup 200 are arranged in an aerosol generating device, the component 170 may supply liquid, or assist in supplying liquid to the wick 100. For example, the component 170 may be a liquid reservoir, or a secondary wick 100 for supplying liquid to the wick 100. The liquid is transported through the wick 100 towards the portion of the wick 100 surrounded by the susceptor. The susceptor 140 is made from a suitable magnetic material such that when an alternating current is passed through the induction coils 160, an eddy current is induced in the susceptor 140. In an example, the induction coils 160 are typically arranged on the outside of the cup 200, and are annular. Of course, other configurations of the induction coil 160 are possible. Additionally or alternatively, the induction coils may be provided within the wall 210 of the cup 200, or on the inside surface of the cup 200. The susceptor 140 is configured to heat up because of the eddy current, thereby heating and vaporising liquid in the wick 100 that is in proximity to the susceptor 140. The induction coils 160 may be activated manually, for example pressing a button on the casing of the aerosol generating device, or automatically, for example in response to the user inhaling air through the device.

Note that the combination of the susceptor 140 and an induction coil 160 is just one way of heating the liquid in the wick 100. It will be appreciated that many well known alternatives for heating e-liquid exist, such as resistive heating, and laser heating can be employed and these can be employed as an alternative to the type described above.

The width of the gap 205 is an important factor for optimising the airflow path 150 and operation of the wick 100. The gap 205 must have a width suitable for allowing a sufficient volume of air to flow through the airflow path 150, while at the same time not being so narrow that the heat induced in the susceptor 140 causes the cup 200 to be burned, or so wide that the induction coils 160 cannot efficiently induce a an eddy current in the susceptor 140. To this end, in some examples, the cup 200 may be formed of heat resistant material such as polyetheretherketone, PEEK, or ceramic. Other heat resistant materials could of course be used. One example of another heat resistant material is polyimide.

Additionally, if the gap 205 is too large, the velocity of the air flow in the airflow path 150 may be lowered, which causes the vapor to become too hot, negatively affecting the user experience. The thickness of the cup 200 is also important for ensuring that the induction coils 160 are not located at too great a distance from the susceptor 140. Specifically, the wall 215 of the cup 200 cannot be too thick, otherwise the distance between the induction coils 160 and the susceptor 140 may become too large for efficient induction heating.

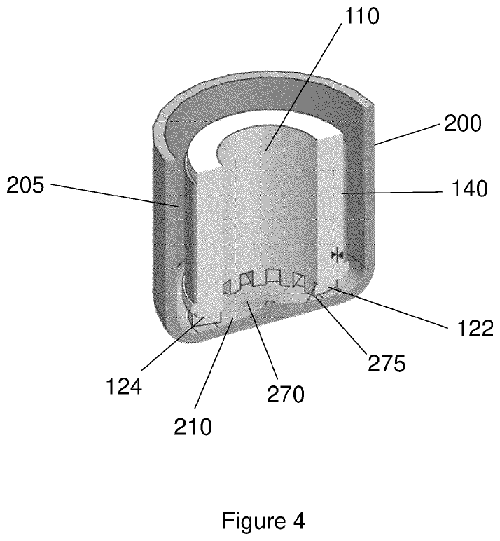

FIG. 4 provides a cross-sectional view of the schematic shown in FIG. 3. It can be seen that indentations 122 and 124 of wick 100 engage the base 210 of the cup 200, thereby defining a gap 205 for allowing air to flow from the exterior of the wick 100 into the hollow core 110. The liquid reservoir is not shown.

One of the advantages provided by the wick 100 is that when the indentations 122, 124 engage with a cup 200, as shown in FIGS. 3 and 4, then not only is an airflow path 150 defined, but collection of unvaporised e-liquid is facilitated. For example, if the wick 100 leaks e-liquid, or some other liquid is collected at the base of the cup 200, then this may be wicked away by the part of the wick 100 in physical contact with the base of the cup 200, i.e. the castellation. In this way, e-liquid is reabsorbed into the wick 100, where it may be heated by the susceptor 140 and eventually inhaled. This prevents the liquid from being wasted, and well as prevents liquid from leaking out of an aerosol generating device.

Referring again to FIG. 4, in some examples, to facilitate more efficient wicking of liquid collected at the base 210, the base 210 of the cup 200 may comprise a central raised portion 270, which falls away to a lower portion 275 along a taper. This encourages liquid to flow from the center of the cup 200 to the edges, where a castellation may wick the liquid away. The taper is typically linear, but any kind of curvature could be used to encourage liquid to flow to the edge.

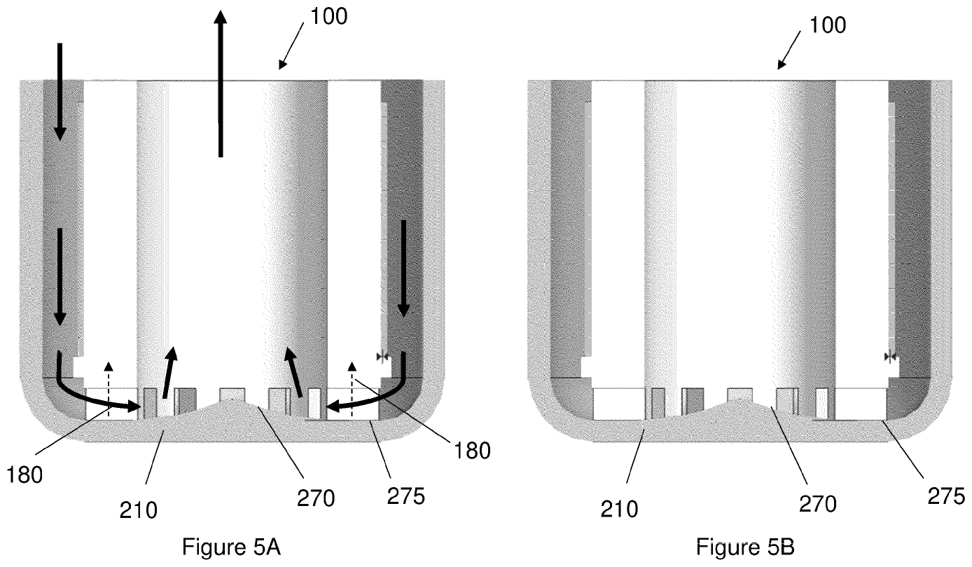

FIGS. 5A and 5B show a cross-sectional view of the wick 100 and cup 200 arrangement shown in FIG. 4. It can be seen that the raised central section 270 encourages liquid towards the outer edges of the cup 200, a lower portion 275. Arrows 180 show that liquid is absorbed into the wick 100 from the lower portion 275. This is an effective way of preventing liquid from pooling at the base 210 of the cup 200, and ultimately prevents the liquid from being wasted.

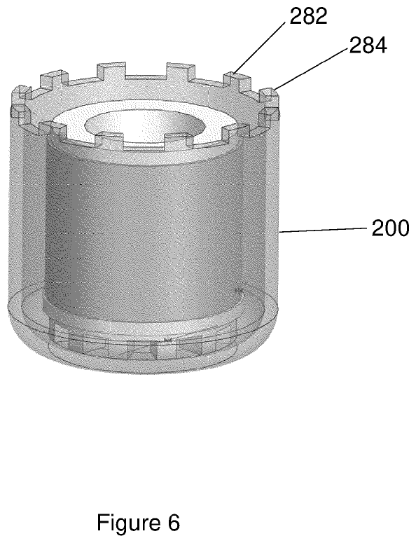

FIG. 6 shows another example of a wick 100 housed in cup 200. In this example, the cup 200 includes at least one indentation at one end of the cup 200. In FIG. 6, a plurality of indentations are shown, for example, indentations 282 and 284. In use, the indentations of the cup 200 engage another surface, for example another surface in an aerosol generating device, thereby providing structural support for the surface while maintaining an airflow path. The indentations 282, 284 provided on the cup 200 are also defined by a height and a width, and may be modified in any way that the indentations 122, 124 of the wick 100 can be modified. For example, the alignment of the indentations relative to the radial direction of the cup 200 may be modified, and so can the number of indentations, as well as the height and width of the indentations.

The wick 100 described above is suitable for being arranged in an aerosol generating device. When in the device, the wick 100 is in fluidic contact with a liquid reservoir. The aerosol generating device may be provided with a power source connected to the induction coils 160, or other heating element for heating fluid in the wick, as well as a number of other components typically provided with an aerosol generating device. An aerosol generating device provided with the wick 100 as described may provide the advantage of preventing waste of liquid in the liquid reservoir.

In conclusion, the wick 100 described above includes at least one indentation, which in use, engages a cup 200 to define an airflow path 150 from the exterior of the wick 100 into the hollow core 110 of the wick 100. This provides advantages over previous wicks in that the wick 100 is able to form part of the airflow path, also prevents e-liquid from being wasted, and mixes vapor with inhaled air in a consistent and predictable way.

It is to be understood that the above described wick 100 may be modified according to design choices and manufacturer's preferences. For example, the radius and length of the wick 100 may be adjusted according to a design specification.

The foregoing description of illustrative embodiments have been presented for purposes of illustration and of description. It is not intended to be exhaustive or limiting with respect to the precise form disclosed, and modifications and variations are possible in light of the above teachings or may be acquired from practice of the disclosed embodiments.

1. A cylindrical ceramic wick for an aerosol generating device, the wick comprising a hollow core and a base, wherein
the base comprises at least one indentation arranged such that, when, in use, the at least one indentation engages with a cylindrical cup, an airflow path for allowing air to flow from an exterior of the wick into the hollow core is defined.

2. The wick of claim 1, wherein the at least one indentation is formed by sintering, or by machining the base.

3. The wick of claim 1, further comprising a cylindrical susceptor arranged on an outer surface of the wick, wherein the susceptor comprises a magnetic material.

4. The wick of claim 1, wherein the wick is housed by a cylindrical cup.

5. The wick of claim 4, wherein the cylindrical cup comprises at least one annular induction coil.

6. The wick of claim 4, wherein a gap between the wick and the cup defines the airflow path.

7. The wick of claim 1, wherein the at least one indentation comprises between 2 and 20 indentations.

8. The wick of claim 1, wherein each of the at least one indentation is defined by a height, the height being between 0.1 mm and 5 mm.

9. The wick of claim 1, wherein each of the at least one indentation is defined by a width, the width being between 0.5 mm and 10 mm.

10. The wick of claim 9, wherein the width of each of the at least one indentation varies across a length of the indentation.

11. The wick of claim 1, wherein each of the at least one indentation extends in a radial direction of the wick.

12. The wick of claim 1, wherein each of the at least one indentation extends at an angle not aligned with a radial direction of the wick.

13. The wick of claim 4, wherein the cup is formed of a heat resistant material.

14. The wick of claim 13, wherein the heat resistant material is at least one of polyetheretherketone, PEEK, polyimide or ceramic.

15. The wick of claim 4, wherein the cup comprises a wall with a thickness between 0.2 mm and 4 mm.

16. The wick of claim 4, wherein the cup comprises an interior base with a raised tapered central section.

17. The wick of claim 4, wherein the cup comprises a first end which forms at least one indentation defined by a width and a height.

18. An aerosol generating device comprising the wick of claim 1.
